(19) United States
(12) Patent Application Publication
(10) Pub. No.: US 2025/0232493 A1
(43) Pub. Date: Jul. 17, 2025

(54) STATISTICAL RECONSTRUCTION METHOD BASED ON A DISCRETE-TO-DISCRETE DATA MODEL WITH ITERATIVE COORDINATE DESCENT OPTIMIZATION STRATEGY FOR EMISSION TOMOGRAPHY

(71) Applicant: CZESTOCHOWA UNIVERSITY OF TECHNOLOGY, Czestochowa (PL)

(72) Inventor: Robert CIERNIAK, Czestochowa (PL)

(21) Appl. No.: 18/412,594

(22) Filed: Jan. 14, 2024

(51) Int. Cl. G06T 11/00

(52) U.S. Cl. CPC G06T 11/008; G06T 2210/41; G06T 2211/424

(57) ABSTRACT

An iterative statistical algorithm based on a discrete-to-discrete data model with iterative coordinate descent optimization for image reconstruction from radiation measurements obtained in emission tomography, i.e. in a Positron Emission Tomography scanner, is described in this invention. The method presented here allows for the presence of the regularization as an additive term. Furthermore, this method makes it possible to control the convergence of the algorithm using a specific parameter. These improvements are due to the signals obtained regarding the given statistics of this imaging technique.

### TECHNICAL FIELD

Invention relates to medical positron emission tomography, and particularly to the image reconstruction method in imaging techniques belonging to this category.

### BACKGROUND OF THE INVENTION

Medical imaging is one of the most useful diagnostic tools available to medicine. The invention presented here relates to one of the most popular imaging techniques belonging to the emission tomography category: positron emission tomography (PET). This medical imaging technique allows us to look inside a person and obtain images that illustrate various biological processes and functions. In this technique, a patient is initially injected with a radiotracer, which contains bio-chemical molecules. These molecules are tagged with a positron emitting radioisotope, and can participate in physiological processes in the body. After the decay of these radioisotope molecules, positrons are emitted from the various tissues of the body which have absorbed the molecules. As a consequence of the annihilation of the positrons, pairs of gamma photons are produced and are released in opposite directions. In PET scanners, these pairs of photons are registered by detectors and counted. A pair of detectors detecting a pair of gamma photons at the same time constitutes a line of response (LOR). A count of photons registered on a certain LOR will be called a projection. Data associated with annihilation events along different LORs are collected and processed. A given set of projections is mostly formed as a so-called sinogram based on their corresponding LORs.

The goal of the PET is to reconstruct the distribution of the radiotracer in the tissues of the investigated cross-sections of the body based on a set of projections from various LORs obtained by the PET scanner. The problem formulated in this way is called an image reconstruction from projections problem and is solved using various reconstruction methods. Because of the relatively small number of annihilations observed in a single LOR, the statistical nature of the measurements performed has a strong influence and must be taken into account. Recently, some new concepts regarding reconstruction algorithms have been applied to emission tomography techniques (i.e. to positron emission tomography (PET)), with statistical approaches to image reconstruction being particularly preferred (see e.g. [1], [2]). The standard reconstruction method used in PET is the maximum likelihood-expectation maximization (ML-EM) algorithm, as described for example in [3][4]. In this algorithm an iterative procedure is used in the reconstruction process, as follows:

$${f}_{l}^{t + 1} = {f}_{l}^{t} \frac{1}{{\sum }_{k} {a}_{kl}} {\sum }_{k} {a}_{kl} \frac{{λ}_{k}}{{\sum }_{{l}^{′}} {a}_{{kl}^{′}} {f}_{{l}^{′}}^{t}} , \qquad ( 1 )$$

where: ƒₗ is an estimate of the image representing the distribution of the radiotracer in the body; l=1, . . . , L is an index of pixels; t is an iteration index; λₖ is the number of annihilation events detected along the k-th LOR; αₖₗ is an element of the system matrix.

It should be underlined that using this algorithm it is impossible to control the speed of its convergence, and in consequence, to use so called “early stopping” regularization strategy.

Modification of this method, i.e. using ordered subset expectation maximization (OSEM), and improvements in computing speed, have allowed for iterative algorithms to be used in the standard clinical practice of PET devices.

Because reconstruction problem (1) is ill-conditioned, it is possible to use a regularization of it, according to the following relation (see e.g. [5]):

$${f}_{l}^{t + 1} = {f}_{l}^{t} \frac{1}{{\sum }_{k} {a}_{kl} + β {R}_{l}^{t}} {\sum }_{k} {a}_{kl} \frac{{λ}_{k}}{{\sum }_{{l}^{′}} {a}_{{kl}^{′}} {f}_{{l}^{′}}^{t}} , \qquad ( 2 )$$

where: Rₗ^{t} is the derivative of a penalty function V with respect to the image pixel ƒₗ^{t}; β is a control parameter.

It should be underlined that the above form of regularization is very inconvenient for a computer implementation of the algorithm (2).

This algorithm is presented in the literature as being more robust and flexible than analytical inversion methods because it allows for accurate modeling of the statistics of the measurements obtained in the PET, i.e. the Poisson statistical distribution of the annihilations detected on the LORs.

The image processing methodology used in this algorithm is consistent with the discrete-to-discrete data model, where the reconstructed image is conceptually divided into homogeneous blocks representing pixels. In this conception, the elements of the system matrix αₖₗ are determined for every pixel/separately, for every annihilation event λₖ detected along the k-th LOR. Bearing in mind the non-zero width of the radiation detector, it is easy to ascertain the set of image blocks that have an influence on the formation of the measurement λₖ. As the ray passes through the test object (the image), all the squares through which part of the ray passes are taken into consideration. The next step is to consider the contribution made by each image block to the way in which each LOR passes through. This contribution can be calculated, for example, by counting the sub-blocks of a given block l through which the LOR k passes.

The author of this invention has devised a new statistical approach to the image reconstruction problem, which is consistent with the discrete-to-discrete data model.

### BRIEF DESCRIPTION OF THE DRAWINGS

FIG. 1 shows a general view of a PET scanner.

FIG. 2 depicts the orientation in the x-y-z coordinates of the measurement system of a PET scanner, in a three-dimensional perspective view.

FIG. 3. shows the geometry of a line of response.

FIG. 4. depicts the strip assigned to a given LOR.

FIG. 5. depicts the block schematic diagram of a method used to practice the present invention, showing a connection to a computed tomography apparatus.

FIG. 6. depicts the block schematic diagram of an iterative reconstruction process.

FIG. 7. is a prior art reconstructed image of a mathematical phantom using the FBP algorithm.

FIG. 8. is a prior art reconstructed image of a mathematical phantom using the standard ML-EM algorithm

FIG. 9. is a reconstructed image of a mathematical phantom using the reconstruction method which embodies the presented invention.

### BRIEF DESCRIPTION OF THE INVENTION

The reconstruction method proposed in this invention is based on a discrete-to-discrete data model like as in the traditional iterative statistical ML-EM reconstruction procedure, as described by Eq. (1). In contrast to the traditional ML-EM algorithm, in this invention the update of the pixels in the reconstructed image is conducted according to the iterative coordinate descent strategy, as follows:

$${f}_{l}^{t + 1} = {f}_{l}^{t} - ρ ( {\sum }_{k} {a}_{kl} \frac{{λ}_{k}}{{\sum }_{{l}^{′}} {a}_{{kl}^{′}} {f}_{{l}^{′}}^{t}} - {g}_{l} ) , \qquad ( 3 )$$

$$where :$$

$${g}_{l} = {\sum }_{k} {a}_{kl} , \qquad ( 4 )$$

and ρ is a coefficient.

In consequence of the new form of the iterative update formula, it is impossible to control the speed of convergence of it, and to use so called “early stopping” regularization strategy (without any regularization term). However, it is possible also to use an additive Tikhonov-type regularization of the formula (3) according to the following relation:

$${f}_{l}^{t + 1} = {f}_{l}^{t} - ρ ( {\sum }_{k} {a}_{kl} \frac{{λ}_{k}}{{\sum }_{{l}^{′}} {a}_{{kl}^{′}} {f}_{{l}^{′}}^{t}} - {g}_{l} ) - β {R}_{l}^{t} , \qquad ( 5 )$$

where: Rₗ^{t} is the derivative of a penalty function V with respect to the image pixel ƒₗ^{t}; β is a control parameter.

It should be underlined that the form of regularization from Eq. (5) is very convenient for a computer implementation of this iterative algorithm in comparison to the standard form from the Eq. (2).

The method for reconstructing the image of an examined object using measurements obtained by a PET scanner comprises: establishing a gamma radiation detector array, calculating the coefficients of the matrix αₖₗ, measuring the gamma radiation from a patient's body by using a PET scanner to obtain a projection dataset and performing an iterative reconstruction procedure. All the geometrical conditions of the measurements are fitted into a matrix of coefficients, which is determined based on the geometrical relations between squares assigned to the pixels in reconstructed image and stripes assigned to the measurement rays.

During the iterative reconstruction procedure, in every iteration, the elements ƒₗ of the reconstructed image are multiplied by the corresponding elements of the matrix αₖₗ, and the results of these multiplications are summed. After this, every element of the matrix Δₖ representing performed measurements by the corresponding elements of the resulting matrix of these multiplications and summations is divided. Next, the elements of the resulting matrix of these divisions by the corresponding elements of the matrix αₖₗ are multiplied, and the results of these multiplications are summed, establishing a biased correction matrix. After this, from every element of the biased correction matrix the corresponding element of the matrix gₗ is subtracted, establishing a correction matrix. Next, every element of the matrix representing the reconstructed image is corrected by subtracting the corresponding element of the correction matrix multiplied by a constant coefficient from the value of this element. A criterion for stopping the iterative process is implemented. No geometric correction of the measurements obtained from the PET scanner is performed.

The coefficients αₖₗ used in the iterative reconstruction process are established according the geometrical relations between squares assigned to the pixels in reconstructed image and stripes assigned to the measurement rays.

The coefficients gₗ used in the iterative reconstruction process are established according to the relation in Eq. (4).

### DETAILED DESCRIPTION

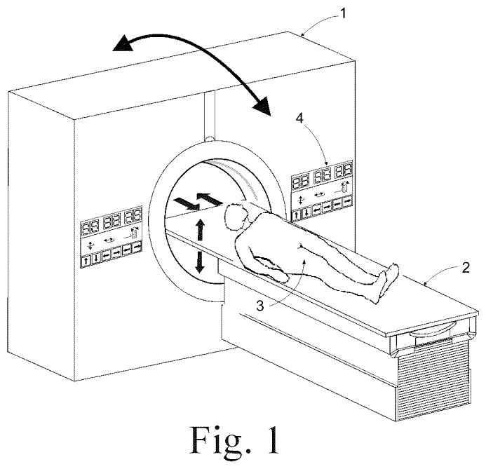

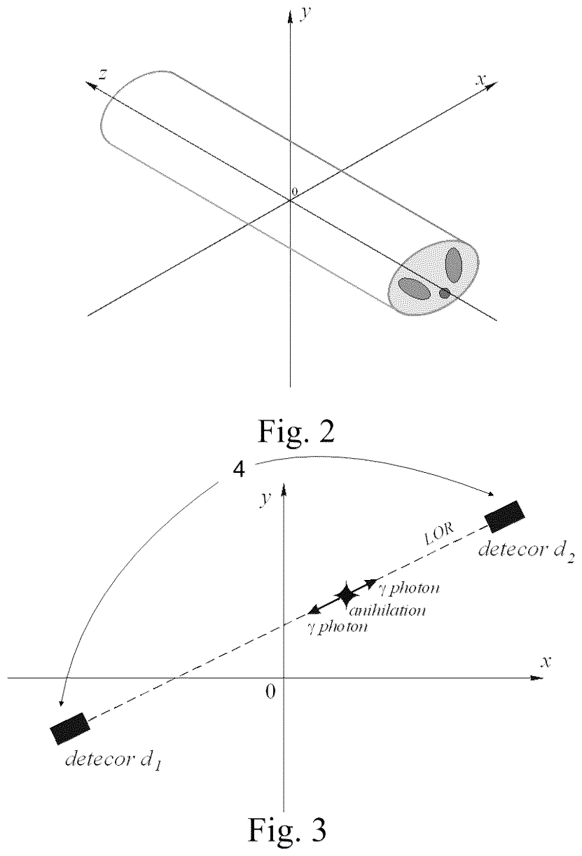

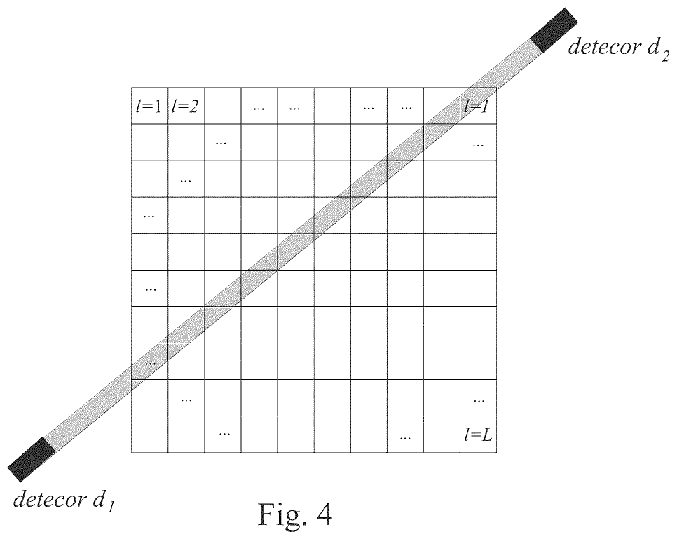

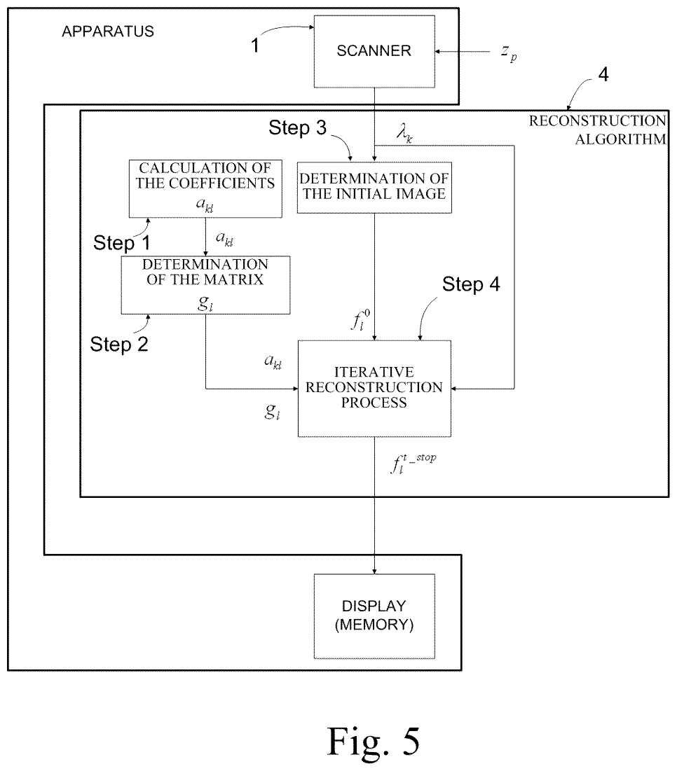

A general scheme of the PET apparatus is shown in FIG. 1. The apparatus consists of three main parts: a positron emission tomography (PET) scanner 1, a support or couch 2 (on which the patient 3 to be examined is placed), and a computer (which is used to control the whole device and perform the reconstruction procedure). The image reconstruction method described here is carried out using the count of the gamma photon pairs, which is obtained by the measuring system installed in the scanner 1. FIG. 2 shows the projection system of the PET scanner in a three-dimensional perspective view oriented in an x-y-z coordinate system. The pair of detectors simultaneously detecting the pair of gamma photons constitutes a line of response (LOR) and is depicted in FIG. 3. Every measurement registers photons on a particular LOR using pairs of detectors. placed around the patient. Data associated with annihilation events along different LORs are collected and then processed. These direct measurements are processed statistically and then the input signals for the reconstruction procedure are obtained, denoted below as λₖ, where k is a number of a given LOR in a certain set of measurements. An example of a strip assigned to a given LOR is depicted in FIG. 4. Next, all the signals λₖ obtained are used for the reconstruction of the cross-section with its center located at the position zₚ, using the algorithm described by FIG. 5.

Having all the values λₖ, the reconstruction algorithm 4 can be started, as specified in the following steps.

### Step 1.

Before the main reconstruction procedure is started, the αₖₗ coefficients matrix is established. The elements of the system matrix αₖₗ are determined for every pixel l separately, for every annihilation event λₖ detected along the k-th LOR. Bearing in mind the non-zero width of the radiation detector, it is easy to ascertain the set of image blocks that have an influence on the formation of the measurement λₖ (see FIG. 4). As the ray passes through the test object (the image), all the squares through which part of the ray passes are taken into consideration. All the calculations in this step of the reconstruction procedure presented here can be pre-calculated, i.e. they can be carried out before the scanner performs any of the necessary measurements.

The output for this step is a matrix with the coefficients αₖₗ; k=1, 2, . . . , K; l=1, 2, . . . , L. If the reconstructed image has dimensions l×I then this matrix has dimensions K×L, where L=I² is a number of pixels in the reconstructed image, K is a total number of performed measurements. It should be noted that if a given ray k do not overlap a given pixel l then αₖₗ=0.

### Step 2.

In this step, a matrix gₗ is determined based on the matrix of the coefficients αₖₗ, obtained in Step 1. This operation is performed according to the relation:

$${g}_{l} = {\sum }_{k} {a}_{kl} , \qquad ( 5 )$$

All the calculations in this step of the presented reconstruction procedure can be pre-calculated, i.e. they can be carried out before the scanner performs any of the necessary measurements.

The output of this step is the matrix gₗ; l=1,2, . . . , I².

### Step 3.

In this step, the initial image for the iterative reconstruction procedure is determined. It can be any image ƒₗ⁰.

The output of this step is the initial reconstructed image ƒₗ⁰; l=1,2, . . . , I².

### Step 4.

The reconstructed image ƒₗ^{t} can be processed by the iterative reconstruction process as a sub-procedure of the reconstruction algorithm using the matrices αₖₗ and gₗ. The image obtained in Step 3 is used as the initial image ƒₗ⁰ for this sub-procedure.

The output of this step is the reconstructed image ƒₗ^{t_stop}, l=1,2, . . . , I².

The image obtained in this way is destined to be presented on a screen for diagnostic interpretation using a different method of presentation developed for PET imaging techniques.

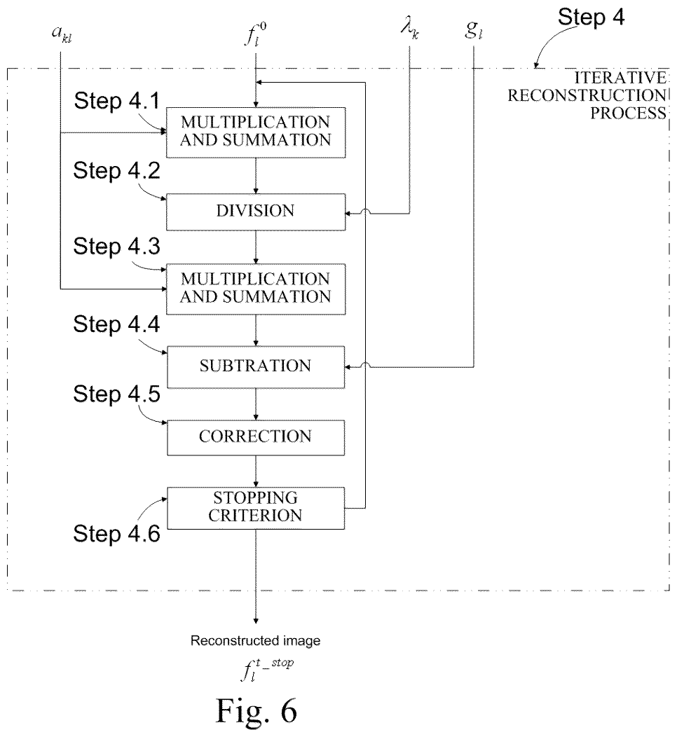

The iterative reconstruction procedure performed in Step 4 consists of several sub-operations as presented in FIG. 6, as follows.

### Step 4.1.

In this step, every element of the matrix ƒₗ^{t} is multiplied by the corresponding element of the matrix αₖₗ (obtained in Step 1), and all the results of these multiplications are summed. This process is repeated for every index k of the matrix αₖₗ.

In this way, the matrix bₖ^{t} with dimension K is produced.

### Step 4.2.

In this step, every element of the matrix λₖ is divided by the corresponding elements of the matrix bₖ^{t} (obtained in Step 4.1).

In this way, the matrix cₖ^{t} with dimension K is produced.

### Step 4.3.

In this step, every element of the matrix cₖ^{t} is multiplied by the corresponding element of the matrix αₖₗ (obtained in Step 1), and all the results of these multiplications are summed. This process is repeated for every index/of the matrix αₖₗ.

In this way, the biased correction matrix dₗ^{t} with dimension L is produced.

### Step 4.4.

In this step, from every element of the biased correction matrix dₗ^{t} the corresponding element of the matrix gₗ (obtained in Step 2) is subtracted.

In this way, the biased correction matrix eₗ^{t} with dimension L is produced.

### Step 4.5.

In this step, from every element of the reconstructed image a correction operation is performed, according to the following relation

$${f}_{l}^{t + 1} = {f}_{l}^{t} - ρ \cdot {e}_{l}^{t} , \qquad ( 6 )$$

where ρ is a constant coefficient.

The output for this step is the next estimation of the reconstructed image ƒₗ^{t+1}; l=1,2, . . . , L.

### Step 4.6.

In this step, a decision is made as to whether the iterative process is to continue or not. This decision can be made based on a subjective evaluation of the reconstructed image quality at this stage of the reconstruction process (whether the quality of reconstructed image is satisfactory). Alternatively, the reconstruction process can be stopped after a number of iterations established in advance.

If the reconstruction process is continued, then image ƒₗ^{t+1} is the input matrix (representing the reconstructed image) for the next iteration of the iterative reconstruction process 4, i.e. ƒₗ^{t}=ƒₗ^{t+1}, or if it is not continued, then image ƒₗ^{t+1} is considered to be the final reconstructed image, i.e. ƒₗ^{t_stop}=ƒₗ^{t+1}.

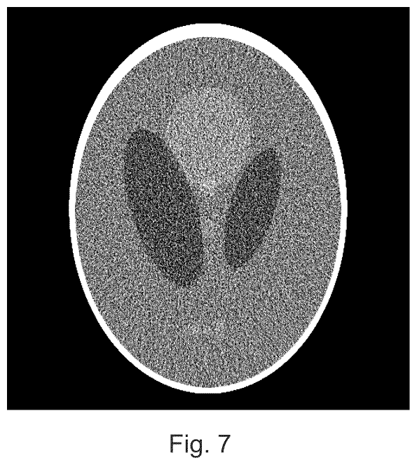

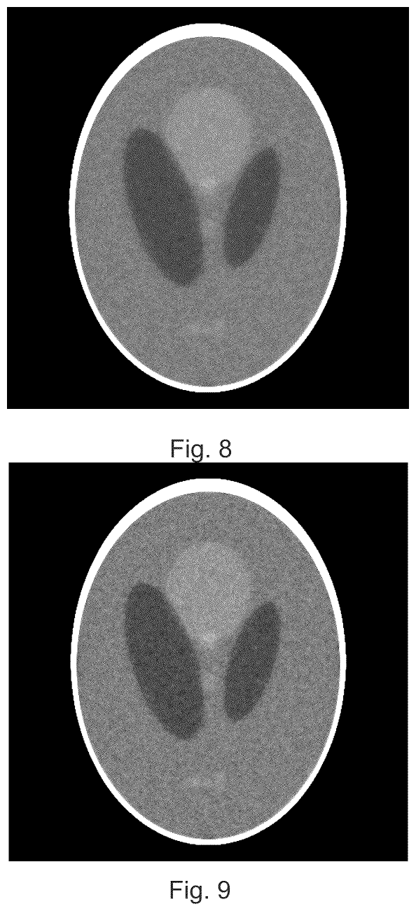

Using this image reconstruction method and apparatus to practice the invention presented here, image artifacts and distortion are significantly reduced in comparison to the analytical FBP methods (see FIG. 7 and FIG. 9), and noticeably reduced in comparison to the traditional ML-EM algorithm described by Eqs. (1) or (2) (see FIG. 8 and FIG. 9). In consequence, this improves the resolution of the reconstructed images and/or decreases the tracer dosage absorbed by a patient during the examination, while maintaining the quality of the PET images obtained. This is because the dosage is strongly related to the resolution of the images obtained. Moreover, in consequence of the new form of the iterative update formula (3), it is possible to control the speed of convergence of this algorithm, and to use so called “early stopping” regularization strategy (without any regularization term) using parameter ρ in the formula (6). However, it is possible also to use an additive Tikhonov-type regularization for the formula (3) according to the relation (5). This form of regularization is much more convenient for a computer implementation of this iterative algorithm in comparison to the standard form from the relation (2).

### REFERENCES CITED

U.S Patent Documents
7,769,217 B2 08/2010 Hamill et al.

### OTHER PUBLICATIONS

[1] K. Sauer, C. Bouman, A local update strategy for iterative reconstruction from projections, IEEE Transactions on Signal Processing, vol. 41, No. 3, pp. 534-548, 1993.
[2] J. A. Fessler, Penalized weighted least-squares image reconstruction for positron emission tomography, IEEE Transactions on Medical Imaging, vol. 13, No. 2, pp. 290-300, 1994.
[3] L. A. Shepp, Y. Vardi, Maximum likelihood reconstruction for emission tomography, IEEE Transactions on Medical Imaging, vol. MI-1, No. 2, pp. 113-122, 1982.
[4] P. J. Green, Bayesian reconstructions from emission tomography data using a modified EM algorithm, IEEE Transactions on Medical Imaging, vol. 9, No. 1, pp. 84-93, 1990.
[5] Zeng L., Extension of emission EM look-alike algorithms to Bayesian Algorithms, 17^{th} International Meeting on Fully Three-Dimensional Image Reconstruction in Radiology and Nuclear Medicine, Proc. SPIE vol. 11072, 2019.

1. A method for performing an iterative reconstruction process, forming part of a method for reconstructing an image of an examined object using a positron emission tomography scanner, is carried out by a procedure comprising of:
multiplying elements of a reconstructed image represented by a matrix ƒₗ^{t} by corresponding elements of a matrix αₖₗ whose elements are determined before the iterative reconstruction process is started, and summation of all the results of these multiplications; this process is repeated for every index k of the matrix αₖₗ; the resulting matrix is a matrix bₖ^{t};
dividing all the values of a matrix λₖ, obtained after the measurements performed in the scanner, by the corresponding elements of the matrix bₖ^{t}, obtained as a result of the previous step of the iterative reconstruction process; the resulting matrix is a matrix cₖ^{t};
multiplying elements of the matrix cₖ^{t}, obtained as a result of the previous step of the iterative reconstruction process, by corresponding elements of the matrix αₖₗ whose elements are determined before the iterative reconstruction process is started, and summation of all the results of these multiplications; this process is repeated for every index l of the matrix αₖₗ; the resulting matrix is a matrix dₗ^{t};
subtracting from all the values of the matrix dₗ^{t}, obtained as a result of the previous step of the iterative reconstruction process, the corresponding elements of a matrix gi whose elements are determined according to the relation (5) before the iterative reconstruction process is started; the resulting matrix is a matrix eₗ^{t};
performing a correction of the reconstructed image represented by the matrix ƒₗ^{t} using corresponding elements of the matrix eₗ^{t}, obtained as a result of the previous step of the iterative reconstruction process;
using a criterion for stopping the iterative process.

2. A method of performing an iterative reconstruction process, which forms part of a method of tomographic imaging, is carried out by steps which comprise:
multiplying elements of a reconstructed image represented by a matrix ƒₗ^{t} by corresponding elements of a matrix αₖₗ whose elements are determined before the iterative reconstruction process is started, and summation of all the results of these multiplications; this process is repeated for every index k of the matrix αₖₗ; the resulting matrix is a matrix bₖ^{t};
dividing all the values of a matrix λₖ, obtained after the measurements performed in the scanner, by the corresponding elements of the matrix bₖ^{t}, obtained as a result of the previous step of the iterative reconstruction process; the resulting matrix is a matrix cₖ^{t};
multiplying elements of the matrix cₖ^{t}, obtained as a result of the previous step of the iterative reconstruction process, by corresponding elements of the matrix αₖₗ whose elements are determined before the iterative reconstruction process is started, and summation of all the results of these multiplications; this process is repeated for every index l of the matrix αₖₗ; the resulting matrix is a matrix dₗ^{t};
subtracting from all the values of the matrix dₗ^{t}, obtained as a result of the previous step of the iterative reconstruction process, the corresponding elements of a matrix gi whose elements are determined according to the relation (5) before the iterative reconstruction process is started; the resulting matrix is a matrix eₗ^{t};
performing a correction of the reconstructed image represented by the matrix ƒₗ^{t} using corresponding elements of the matrix eₗ^{t}, obtained as a result of the previous step of the iterative reconstruction process;
using a criterion for stopping the iterative process.
